(19) United States
(12) Patent Application Publication
(10) Pub. No.: US 2007/0040505 A1
(43) Pub. Date: Feb. 22, 2007

(54) Plasma display panel

(76) Inventors: Kyoung-Doo Kang, Suwon-si (KR); Won-Ju Yi, Suwon-si (KR); Ho-Young Ahn, Suwon-si (KR); Dong-Young Lee, Suwon-si (KR); Soo-Ho Park, Suwon-si (KR); Seok-Gyun Woo, Suwon-si (KR); Jae-Ik Kwon, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/501,311

(22) Filed: Aug. 8, 2006

(30) Foreign Application Priority Data
Aug. 17, 2005 (KR) 10-2005-0075244

(51) Int. Cl. H01J 17/49

(52) U.S. Cl. 313/582

(57) ABSTRACT

Provided is a plasma display panel in which failure of a terminal part structure of discharge electrodes can be prevented. The plasma display panel includes: a pair of panels which are spaced from each other with a predetermined gap therebetween which are opposed to each other; a sheet which is disposed between the pair of panels and includes barrier ribs for defining discharge cells in cooperation with the pair of panels and a dielectric part disposed at an edge of the sheet; discharge electrodes which include discharge parts generating discharge inside the barrier ribs, terminal parts formed in contact with the dielectric part and spaced from each other, and connection parts connecting the discharge parts to the terminal parts; a signal transmission member including wires which are connected to the terminal parts and are spaced from each other, a gap between the wires being smaller than the gap between the terminal parts; phosphor layers which are disposed inside the discharge cells; and discharge gas in the discharge cells. Also provided is a method of making the plasma display panel.

### CROSS-REFERENCE TO RELATED APPLICATIONS

This application claims the benefit of Korean Patent Application No. 10-2005-0075244, filed on Aug. 17, 2005, in the Korean Intellectual Property Office, the disclosure of which is incorporated herein in its entirety by reference.

### BACKGROUND OF THE INVENTION

1. Field of the Invention

The present embodiments relate to a plasma display panel, and more particularly, to a plasma display panel in which a defect in a terminal part of a discharge electrode can be prevented.

2. Description of the Related Technology

Recently, cathode-ray tube display devices have been replaced with plasma display panels. In plasma display panels, a discharge gas is enclosed between two panels, each having a plurality of electrodes. A discharge voltage is applied to the electrodes to generate ultraviolet rays. The ultraviolet rays excite phosphor substances formed in a predetermined pattern to display a desired image.

A plasma display panel may include a front panel and a rear panel disposed to be opposed to each other, a plurality of discharge electrodes disposed between the panels, and a circuit board which drives the plasma display panel.

The plurality of discharge electrodes include address electrodes generating address discharge and sustain electrodes sustaining the discharge. The discharge electrodes are electrically connected to the circuit board through a signal transmission member.

FIG. 1 is a plan view illustrating terminal parts of the address electrodes of such a plasma display panel. FIG. 2 is an enlarged view of portion A of FIG. 1.

As shown in FIGS. 1 and 2, the address electrodes 110 are formed on a rear panel 120. The address electrodes 110 include a discharge part 111, a connection part 112, and a terminal part 113. The terminal parts 113 are electrically connected to wires 131 of a signal transmission member 130, respectively.

When electrical signals for generating address discharge are produced from the circuit board, the electrical signals are transmitted to the discharge parts 111 through the signal transmission member 130, the terminal parts 113, and the connection parts 112. The discharge electrodes serving as scan electrodes among the sustain electrodes generate the Address discharge.

In a plasma display panel, a gap d₁ between the neighboring terminal parts 113 is smaller than a gap d₂ between the neighboring wires 131. Shorting between the terminal parts 113 often occurs due to electrode migration, impurity migration, and foreign substances between the neighboring terminal parts 113.

The discussion in the above section is to provide background information on the technology, and does not constitute admission of prior art.

### SUMMARY OF CERTAIN INVENTIVE ASPECTS

The present invention provides a plasma display panel in which defects in a terminal part of a discharge electrode can be prevented.

Another aspect of the embodiments provide a plasma display panel including: a pair of panels which are spaced from each other with a predetermined gap therebetween and are opposed to each other; a sheet which is disposed between the pair of panels and includes barrier ribs for defining discharge cells in cooperation with the pair of panels and a dielectric part disposed at an edge of the sheet; discharge electrodes which include discharge parts generating discharge inside the barrier ribs, terminal parts formed in contact with the dielectric part and spaced from each other, and connection parts connecting the discharge parts to the terminal parts; a signal transmission member including wires which are connected to the terminal parts and are spaced from each other, a gap between the wires being smaller than the gap between the terminal parts; phosphor layers which are disposed inside the discharge cells; and discharge gas filled in the discharge cells.

The sidewalls of the barrier ribs may be covered with a protective layer. Frit may be disposed between the pair of panels and the dielectric part. The discharge parts may be disposed to surround at least part of the discharge cells. The discharge parts may be disposed in a stripe shape. The grooves may be formed on at least one panel of the pair of panels and the grooves may be coated with the phosphor layer. The signal transmission member may be a flexible printed cable. The signal transmission member may be a tape carrier package. The wires of the signal transmission member and the terminal parts may be connected to each other through an anisotropic conductive film.

Another aspect of the embodiments provide a plasma display panel including: a pair of panels which are spaced from each other with a predetermined gap therebetween and are opposed to each other; barrier ribs which are disposed between the pair of panels and define discharge cells in cooperation with the pair of panels; discharge electrodes which are disposed between the pair of panels and include terminal parts spaced from each other at the ends of the discharge electrodes; a signal transmission member including wires which are connected to the terminal parts and are spaced from each other, the gap between the wires being smaller than the gap between the terminal parts; phosphor layers which are disposed inside the discharge cells; and discharge gas filled in the discharge cells.

The sidewalls of the barrier ribs may be covered with a protective layer. Frit may be disposed between the pair of panels. At least a part of the discharge electrodes may be disposed to surround at least part of the discharge cells. At least a part of the discharge electrodes may be disposed in a stripe shape. The grooves may be formed on at least one panel of the pair of panels and the grooves may be coated with the phosphor layer. The signal transmission member may be a flexible printed cable. The signal transmission member may be a tape carrier package. The wires of the signal transmission member and the terminal parts may be connected to each other through an anisotropic conductive film.

### BRIEF DESCRIPTION OF THE DRAWINGS

The above and other features and advantages of the embodiments will become more apparent by describing in detail exemplary embodiments thereof with reference to the attached drawings in which:

FIG. 1 is a plan view illustrating terminal parts of address electrodes among discharge electrodes of a conventional plasma display panel;

FIG. 2 is an enlarged view of portion A of FIG. 1;

FIG. 3 is a partial exploded perspective view illustrating a plasma display panel according to an insant embodiment;

FIG. 4 is a cross-sectional view taken along Line IV-IV of FIG. 3;

FIG. 5 is a cross-sectional view taken along Line V-V of FIG. 4;

FIG. 6 is a partial exploded perspective view illustrating a plasma display panel according to another embodiment;

FIG. 7 is a cross-sectional view taken along Line VII-VII of FIG. 6; and

FIG. 8 is a cross-sectional view taken along Line VIII-VIII of FIG. 7.

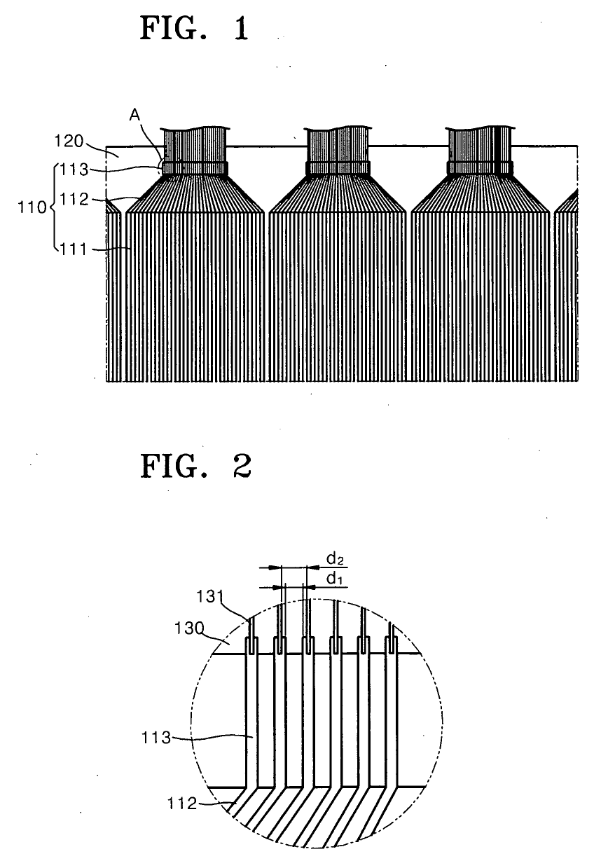

### DETAILED DESCRIPTION OF CERTAIN INVENTIVE EMBODIMENTS

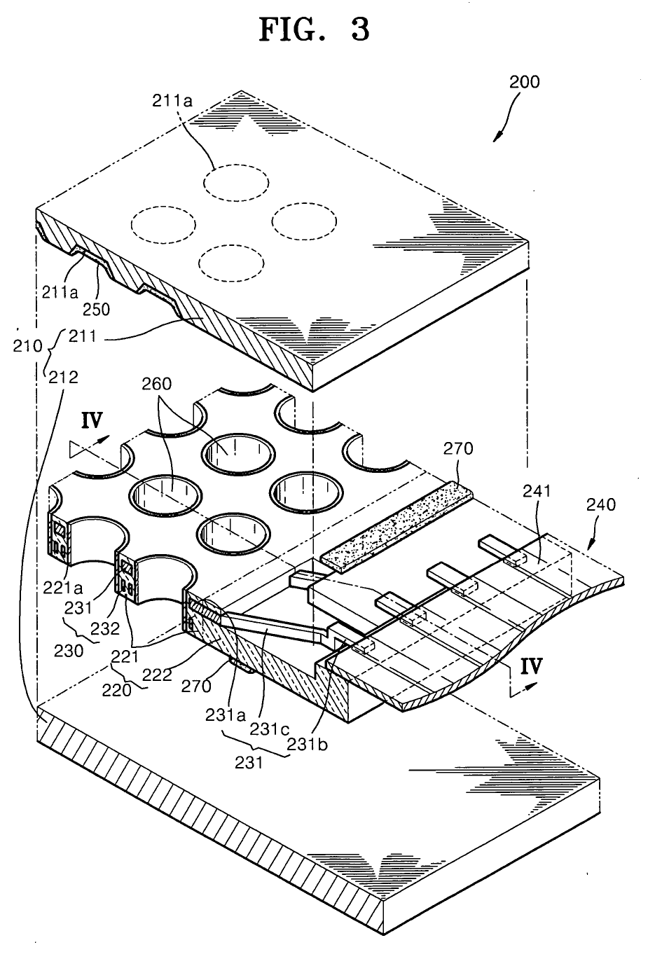

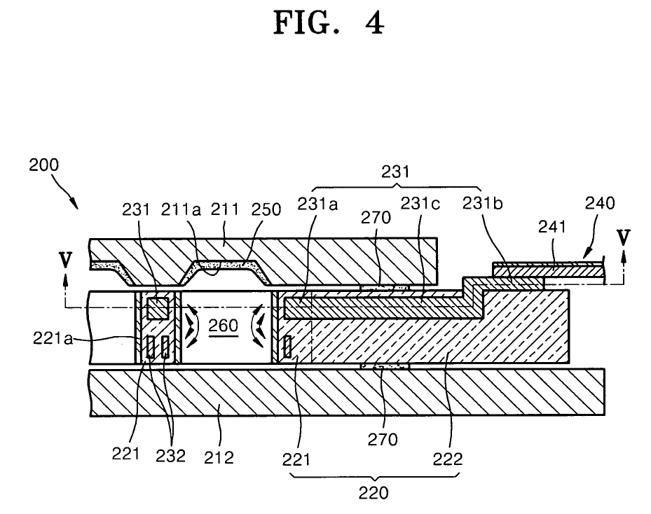

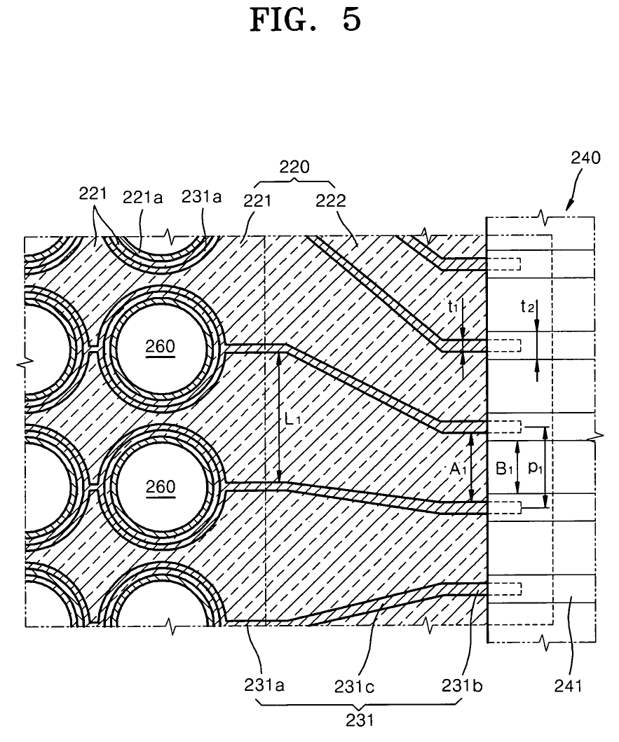

FIG. 3 is a partial exploded perspective view illustrating a plasma display panel according to an embodiment. FIG. 4 is a cross-sectional view taken along Line IV-IV of FIG. 3, and FIG. 5 is a cross-sectional view taken along Line V-V of FIG. 4.

As shown in FIGS. 3 and 4, a plasma display panel 200 according to an embodiment includes a pair of panels 210, a sheet 220, discharge electrodes 230, a signal transmission member 240, and phosphor layers 250.

The pair of panels 210 include a first panel 211 and a second panel 212, which are spaced from each other with a predetermined gap therebetween and are disposed to be opposed to each other. The first panel 211 is made of transparent glass and can transmit visible rays.

In the present embodiment, since the first panel 211 is transparent, visible rays generated due to discharge pass through the first panel 211. However, the present embodiments are not limited thus. That is, the first panel may be opaque and the second panel may be transparent. Alternatively, the first panel and the second panel may be transparent. In addition, the first panel and the second panel may be made of a semitransparent material and color filters may be built on the surface or inside.

The sheet 220 is disposed between the pair of panels 210 and includes barrier ribs 221 and a dielectric part 222. Since the barrier ribs 221 define discharge cells 260, which are spaces for discharge, together with the pair of panels 210, the barrier ribs 221 have a function of defining a display area.

The dielectric part 222 is connected to the barrier ribs 221 and is disposed at an edge of the sheet 220. In the illustrated embodiment, the barrier ribs 221 define the discharge cells 260 of which the inner surfaces are coated with the phosphor layers 250. The entire barrier ribs 221 define a display area on which an image is displayed. The embodiments are not limited thus, and the barrier ribs may define dummy discharge cells which display no image. Here, the dummy discharge cells refer to spaces in which the discharge electrodes or the phosphor layers are not disposed and in which no discharge is generated. The dummy discharge cells may be formed along the inside of the dielectric part 222 or may be positioned between the discharge cells.

In the illustrated embodiment, the horizontal sections of the discharge cells 260 defined by the barrier ribs 221 have a circular shape. However, the embodiments are not limited thus. The horizontal sections may have, for example, a triangular shape, a rectangular shape, a pentagonal shape, or an elliptical shape.

The dielectric substance of the barrier ribs 221 serves to prevent the discharge electrodes 230 from being electrically connected to each other during sustain discharge. This configuration prevents charged particles from directly colliding with the discharge electrodes 230 and damaging the discharge electrodes 230. The dielectric substance also guides and accumulates the charged particles. Examples of the dielectric substance can include, but are not limited to, PbO, B₂O₃, and SiO₂.

In the present embodiment, the dielectric part 222 may include the same dielectric substance as the barrier ribs 221, but the present embodiments are not limited thus. The dielectric substance of the dielectric part may be different from the dielectric substance of the barrier ribs. In this case, a dielectric substance may be properly selected to have a dielectric constant such that discharge is not generated in the dielectric part.

The sidewalls of the barrier ribs 221 are covered with a protective layer 221a. The protective layer 221a may include, for example, magnesium oxide (MgO) and serves to prevent the barrier ribs 221 made of dielectric substances and the discharge electrodes 230 from being damaged due to sputtering of plasma particles and to emit secondary electrons to lower a discharge voltage.

The discharge electrodes 230 include first discharge electrodes 231 and second discharge electrodes 232 disposed apart from the first discharge electrodes 231. Each first discharge electrode 231 includes a discharge part 231a, a terminal part 231b, and a connection part 231c.

First, the structure of the first discharge electrode 231 will be described. The discharge parts 231a are disposed in the barrier ribs 221 and serve to directly generate discharge. The terminal parts 231b are in contact with the dielectric part 222 and are exposed externally for connection to the signal transmission member 240.

Referring to FIG. 5, the gap A₁ between the terminal parts 231b is smaller than the gap L₁ between the discharge parts 231a, thereby facilitating the connection of the terminal parts 231b to the signal transmission member 240.

The gap A₁ between the terminal parts 231b is greater than a gap B₁ between the wires 241 of the signal transmission member 240. Here, the gap A₁ between the terminal parts 231b and the gap B₁ between the wires 241 of the signal transmission member 240 do not mean the pitch p₁ between the central lines thereof, but a distance between the outermost lines thereof. That is, the gap A₁ between the neighboring terminal parts 231b is greater than the gap B₁ between the neighboring wires 241. This means that the width t₁ of the terminal parts 231b is smaller than the width t₂ of the wires 241.

As the gap A₁ between the terminal parts 231b increases, short circuits due to electrode migration, impurity migration, and foreign substances can be prevented between the terminal parts 231b formed on the dielectric part 222, thereby lowering a failure rate of the terminal parts.

The connection parts 231c electrically connect the discharge parts 231a and the terminal parts 231b and are buried in the sheet 220 in the illustrated embodiment. Although the connection parts 231c are buried in the sheet 220 in the present embodiment, The present embodiments are not limited thus. That is, the connection parts may be exposed from the sheet 220 and the positions of the connection parts are not particularly limited.

On the other hand, the second discharge electrodes 232 are formed to intersect with the first discharge electrodes 231. The second discharge electrode 232 may have the same structure as the first discharge electrodes 231. Accordingly, the second discharge electrodes 232 include discharge parts (not shown), terminal parts (not shown), and connection parts (not shown), similar to those of the first discharge electrodes 231 and detailed structures thereof are similar to those of the first discharge electrodes 231.

In the present embodiment, the first discharge electrodes 231 extend in one direction and the second discharge electrodes 232 intersect with the first discharge electrodes 231, thereby performing an addressing operation. However, the embodiments are not limited thus. In other embodiments, the plasma display panel may include additional electrodes performing only the addressing operation, thereby forming a three-electrode structure.

In the present embodiment, the discharge parts 231a of the first discharge electrodes 231 and the discharge parts (not shown) of the second discharge electrodes 232 are disposed to surround the respective discharge cells 260. Thus, the sustain discharge is vertically generated in all the sides of the discharge cells 260. However, the embodiments are not limited thus. In certain embodiments, the first discharge electrodes and the second discharge electrodes may be buried in the barrier ribs in a stripe shape. In this case, the first discharge electrodes and the second discharge electrodes have a discharge path of an opposed discharge type, not a surface discharge type.

As shown in FIG. 5, in the present embodiment, the cross-section of the discharge parts 231a of the first discharge electrodes 231 and the discharge parts (not shown) of the second discharge electrodes 232 have a circular ring shape. However, the embodiments are not limited thus. In other embodiments, the cross-section of the discharge parts of the first discharge electrodes and the second discharge electrodes may have a variety of shapes such as, for example, ellipse, quadrangle, pentagon, and other polygons.

In the present embodiment, since the discharge parts 231a of the first discharge electrodes 231 and the discharge parts of the second discharge electrodes 232 are disposed in the sheet 220, the first discharge electrodes 231 and the second discharge electrodes 232 are not necessarily formed of transparent materials and may include a metal, such as, for example, Ag, Al, or Cu having excellent conductivity and low resistance. In such an embodiment, the response speed to discharge is high. In addition, signals may not be distorted, and the power consumption for the sustain discharge can be reduced.

In one embodiment, the discharge parts 231a of the first discharge electrodes 231 and the discharge parts of the second discharge electrodes 232 are disposed in the sheet 220, but the embodiments are not limited thus. In other embodiments, the first discharge electrodes and the second discharge electrodes may be disposed in the first panel or the second panel. In such embodiments, the first discharge electrodes and the second discharge electrodes may be covered with a dielectric layer.

The signal transmission member 240 is electrically connected to a driving circuit board (not shown) for driving the plasma display panel 200. A flexible printed cable (FPC) or a tape carrier package (TCP) can be used as the signal transmission member 240.

The signal transmission member 240 includes the wires 241 for transmitting electrical signals. As described above, the wires 241 are electrically connected to the terminal parts of the discharge electrodes 230. The wires 241 have a predetermined gap B₁ therebetween.

In one embodiment, the wires 241 of the signal transmission member 240 may be connected to the terminal parts 231b of the first discharge electrodes 231 and the terminal parts of the second discharge electrodes 232 by an anisotropic conductive film.

The phosphor layers 250 are formed in grooves 211a formed in the first panel 211. The grooves form parts of the discharge cells of red, green, and blue. The grooves 211a are formed in portions of the first panel 211 corresponding to the discharge cells 260 by a sand blasting or etching method.

The phosphor layers 250 have materials emitting visible rays in response to ultraviolet rays. A red phosphor layer emitting red visible rays includes a fluorescent substance such as Y(V, P)O₄:Eu. A green phosphor layer emitting green visible rays includes a fluorescent substance such as Zn₂SiO₄:Mn. A blue phosphor layer emitting blue visible rays includes a fluorescent substance such as BAM:Eu (e.g. BaMgAl₁₀O₁₇:Eu²⁺).

In the illustrated embodiment, referring to FIG. 4, the phosphor layers 250 are formed by forming the grooves 211a in the first panel 211 and then coating the grooves 211a with fluorescent substances, but the embodiments are not limited thus. In other embodiments, the phosphor layers may be formed on any part of the discharge cells 260, as long as they are positioned in the discharge spaces and can emit visible rays in response to the ultraviolet rays generated by plasma discharge.

In one embodiment, frit 270 is applied onto the dielectric part 222. The frit 270 serves to bring the pair of panels 210 into close contact with the dielectric part 222 through the use of a predetermined process. The frit 270 also seals the plasma display panel 200.

After sealing the plasma display panel 200, a discharge gas such as, for example, Ne, Xe, or a mixture thereof is injected into the plasma display panel 200.

A process of manufacturing the plasma display panel according to an embodiment and the operation thereof will be described below in detail.

The process of manufacturing the plasma display panel 200 according to an embodiment may include forming the sheet 220; etching the pair of panels 210 and forming the phosphor layers 250; and assembling and sealing the plasma display panel 200 and injecting the discharge gas into the plasma display panel 200.

First, the step of forming the sheet 220 will be described. The dielectric substance is sequentially stacked while burying the discharge parts 231a and the connection parts 231c of the first discharge electrodes 231 and the discharge parts (not shown) and the connection parts (not shown) of the second discharge electrodes 232, thereby forming the sheet 220. Thereafter, openings for the discharge cells 260 are formed in the sheet 220, thereby forming the barrier ribs 221.

After forming the sheet 220, the terminal parts 231b are formed at ends of the connection parts 231c of the first discharge electrodes 231. At this time, the gap A₁ between the terminal parts 231b is greater than the gap B1 between the wires 241 of the signal transmission member 240. The terminal parts (not shown) of the second discharge electrodes 231 have the structure similar to the terminal parts 231b of the first discharge electrodes 231. The protective layer 221a made of magnesium oxide is formed on the side walls of the barrier ribs 221 through the use of a vacuum deposition method.

The parts of the first panel 211 corresponding to the discharge cells 260 are etched by a glass cutting method such as, for example, a sand blast method or an etching method to form the grooves 211a. Then, the fluorescent substances are applied to the grooves 211a to form the phosphor layers 250.

Next, the sheet 220 is interposed and assembled between the pair of panels 210. In the course of assembly, the frit 270 is applied such that the frit 270 is positioned between the pair of panels 210 and the dielectric part 222 of the sheet 220. After the assembly, a vacuum exhaust process is performed and then the discharge gas is injected.

After injection of the discharge gas, the exposed terminal parts 231b and the wires 241 of the signal transmission member 240 are bonded to each other by using an anisotropic conductive film.

The operation of the plasma display panel 200 manufactured through the above-mentioned process will now be described.

After the assembly of the plasma display panel 200 and the injection of the discharge gas, the address discharge is generated in response to application of a predetermined address voltage between the first discharge electrodes 231 and the second discharge electrodes 232. The discharge cells 260 to generate the sustain discharge are selected as a result of the address discharge.

Thereafter, when a discharge sustaining voltage is applied between the first discharge electrodes 231 and the second discharge electrodes 232 of the selected discharge cells 260, wall charges accumulated on the sidewalls of the barrier ribs 221 are migrated by discharge parts 231a of the first discharge electrodes 231 and the discharge parts of the second discharge electrodes 232, thereby generating the sustain discharge. At the time of the sustain discharge, the energy level of the excited discharge gas decreases, thereby emitting the ultraviolet rays.

Then, the ultraviolet rays excite the fluorescent substances of the phosphor layers 250. The energy levels of the excited fluorescent substances decreases, emitting visible rays. The visible rays are emitted through the first panel 211 to display a visible image.

In the illustrated embodiment, the gap A₁ between the neighboring terminal parts is greater than the gap B1 between the neighboring wires 241 of the signal transmission member 240. This configuration prevents short circuits due to electrode migration, impurity migration, and foreign substances between the terminal parts, thereby lowering a failure rate of the terminal parts.

In addition, in the plasma display panel 200 according to the embodiment, the discharge parts 231a of the first discharge electrodes 231 and the discharge parts of the second discharge electrodes 232 surround the discharge cells 260. As a result, the sustain discharge is generated along all the sides of the discharge cells 260, thereby relatively increasing a discharge area and increasing emission brightness and discharge efficiency.

The plasma display panel 200 according to the embodiment includes the sheet 220. As a result, the process of stacking barrier ribs on the panel to form the discharge cells 260 is not required. In the embodiment, since the discharge cells can be formed by forming the quadrangular openings in the sheet 220 to correspond to the discharge cells, the processes can be simplified, thereby reducing the manufacturing cost.

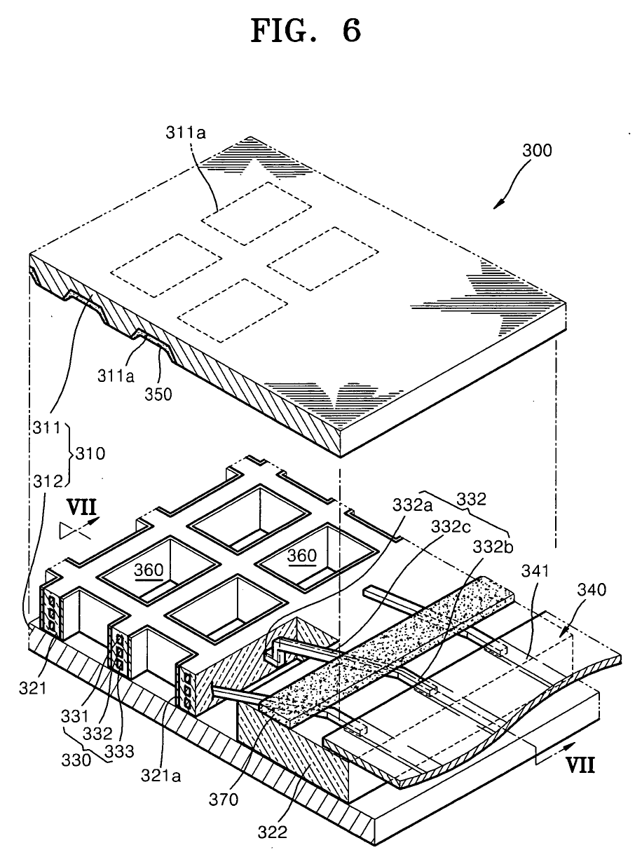

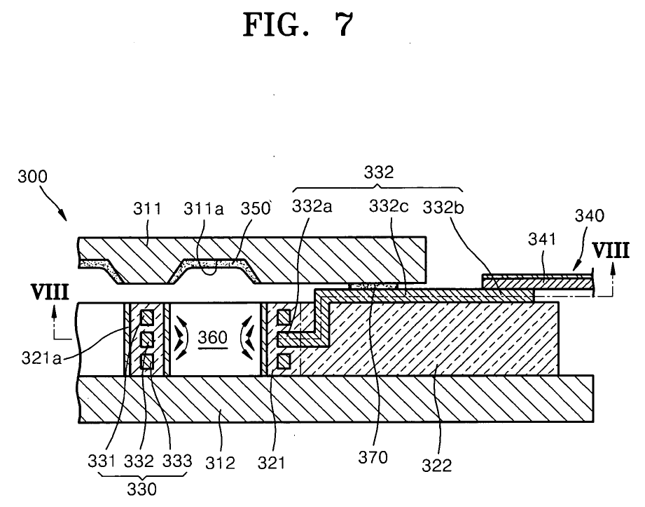

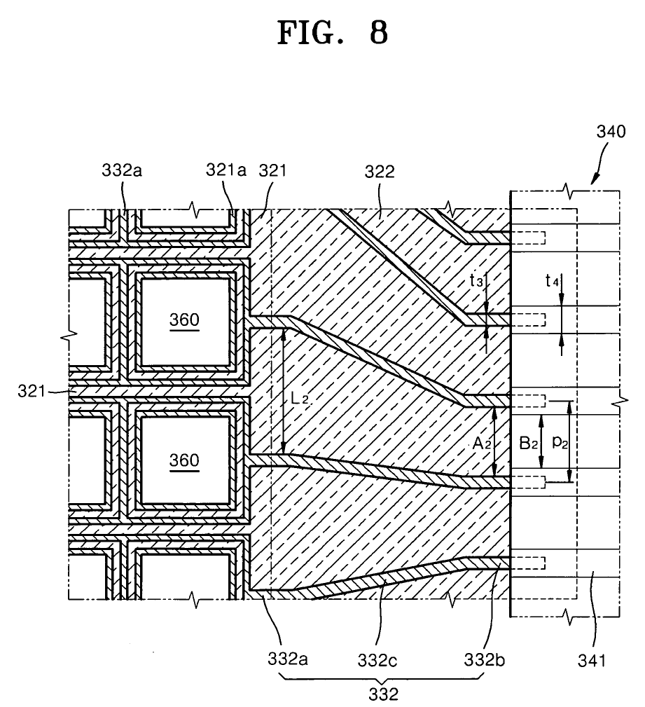

Hereinafter, another embodiment will be described with reference to FIGS. 6 to 8. FIG. 6 is a partial exploded perspective view illustrating a plasma display panel according to another embodiment. FIG. 7 is a cross-sectional view taken along Line VII-VII of FIG. 6. FIG. 8 is a cross-sectional view taken along Line VIII-VIII of FIG. 7.

As shown in FIGS. 6 to 8, a plasma display panel 300 includes a pair of panels 310, barrier ribs 321, a dielectric wall 322, discharge electrodes 330, a signal transmission member 340, and phosphor layers 350.

The pair of panels 310 include a first panel 311 and a second panel 312, which are spaced from each other with a predetermined gap therebetween and are disposed to be opposed to each other. The first panel 311 may be formed of transparent glass and can transmit visible rays.

The barrier ribs 321 are formed on the second panel 312 and define discharge cells 360, which are spaces generating discharge, together with the pair of panels 310. The horizontal section of the discharge cells 360 defined by the barrier ribs 321 can be, for example, quadrangular. The dielectric wall 322 is disposed outside the barrier ribs on the edges of the plasma display panel 300. The dielectric wall 322 is also formed on the second panel 312 and is connected to the barrier ribs 321.

The barrier ribs 321 are made of a dielectric substance. Discharge parts of the first discharge electrodes 331, second discharge electrodes 332, and third discharge electrodes 333 are buried in the dielectric substance. The dielectric substance of the barrier ribs 321 serves to prevent the first discharge electrodes 331, the second discharge electrodes 332, and the third discharge electrodes 333 from being electrically connected to each other during sustain discharge. The dielectric substance prevents charged particles from directly colliding with the first discharge electrodes 331, the second discharge electrodes 332, and the third discharge electrodes 333 to damage the discharge electrodes 331, 332, and 333. The dielectric substance also guides and accumulates the charged particles. Examples of the dielectric substance can include, for example, but are not limited to PbO, B₂O₃, SiO₂, and the like.

In the embodiment, the dielectric wall 322 forms a body along with the barrier ribs 321. The dielectric wall 322 may be formed of the same dielectric substance as the barrier ribs 321, but the embodiments are not limited thus. In other embodiments, the barrier ribs and the dielectric wall may be individually formed and the dielectric wall may have a dielectric constant different from that of the barrier ribs.

The sidewalls of the barrier ribs 321 facing the discharge cells 360 are covered with a protective layer 321a. The protective layer 321a may include, for example magnesium oxide (MgO).

The discharge electrodes 330 include the first discharge electrodes 331, the second discharge electrodes 332 spaced from the first discharge electrodes 331, and the third discharge electrodes 333 spaced from the second discharge electrodes 332.

The first discharge electrodes 331 and the third discharge electrodes 333 may extend in the same direction. The second discharge electrodes 332 may intersect with the first discharge electrodes 331 and the third discharge electrodes 333. Accordingly, the second discharge electrodes 332 serves as address electrodes performing an addressing function.

In the present embodiment, the first discharge electrodes 331, the second discharge electrodes 332, and the third discharge electrodes 333 are provided, but the embodiments are not limited thus. In other embodiments, two groups of discharge electrodes of the first discharge electrodes 331, the second discharge electrodes 332, and the third discharge electrodes 333 may extend in the same direction and the other group may intersect with the two groups of discharge electrodes extending in the same way. In this case, any one group of discharge electrodes extending in the same direction serves as a scan electrode and the other group serves as a common electrode. The remaining one group intersecting with the two groups of discharge electrodes extending in the same direction serve as an address electrode.

Each discharge electrode 330 includes a discharge part, a terminal part, and a connection part. The second discharge electrodes 332 will be described. The discharge parts 332a of the second discharge electrodes 332 are disposed in the barrier ribs 321 and serve to directly generate discharge. The terminal parts 332b are formed on the dielectric wall 322 in contact with the dielectric wall 322 and are exposed externally for connection to the signal transmission member 340.

A gap A₂ between the terminal parts 332b is smaller than a gap L₂ between the discharge parts 332a, thereby facilitating the connection of the terminal parts 332b to the signal transmission member 340. The gap A₂ between the terminal parts 332b is greater than a gap B₂ between the wires 341 of the signal transmission member 340. Here, the gap A₂ between the terminal parts 332b and the gap B₂ between the wires 341 of the signal transmission member 340 do not mean the pitch p₂ between the central lines thereof, but a distance between the outermost lines thereof. That is, the gap A₂ between the neighboring terminal parts 332b is greater than the gap B₂ between the neighboring wires 341. This means that the width t₃ of the terminal parts 332b is smaller than the width t₄ of the wires 341.

As the gap A₂ between the terminal parts 332b increases, short circuits due to electrode migration, impurity migration, and foreign substances can be prevented between the terminal parts 332b formed on the dielectric wall 322, thereby lowering a failure rate of the terminal parts.

The connection parts 332c electrically connect the discharge parts 332a to the terminal parts 332b. In one embodiment, a part of the connection parts 332c are buried in the dielectric wall 322 and the other portions are exposed from the dielectric wall 322.

The first discharge electrodes 331 and the third discharge electrodes 333 are formed to intersect with the second discharge electrodes 332, but may have the same structure as the second discharge electrodes 332. Accordingly, the first discharge electrodes 331 and the third discharge electrodes 333 include discharge parts (not shown), terminal parts (not shown), and connection parts (not shown), similar to the second discharge electrodes 332. Detailed structures thereof are similar to those of the second discharge electrodes 332.

In the present embodiment, the discharge parts (not shown) of the first discharge electrodes 331, the discharge parts 332a of the second discharge electrodes 332, and the discharge parts (not shown) of the third discharge electrodes 333 are disposed to surround the respective discharge cells 360. As shown in FIG. 8, the discharge parts of the first discharge electrodes 331, the second discharge electrodes 332, and the third discharge electrodes 333 can form a ladder shape.

In the present embodiment, since the discharge parts of the first discharge electrodes 331, the discharge parts 332a of the second discharge electrodes 332, and the discharge parts of the third discharge electrodes 333 are disposed inside the barrier ribs 321, they may include a metal, such as, for example, Ag, Al, and Cu, which is excellent in conductivity, low in resistance, and opaque.

The signal transmission member 340 is electrically connected to a driving circuit board (not shown) for driving the plasma display panel 300. A flexible printed cable (FPC) or a tape carrier package (TCP) can be used as the signal transmission member 340.

The signal transmission member 340 includes the wires 341 for transmitting electrical signals. As described above, the wires 341 are electrically connected to the terminal parts of the discharge electrodes 330. The connection of the wires 341 of the signal transmission member 340 to the terminal parts of the discharge electrodes 330 can be made by an anisotropic conductive film.

The phosphor layers 350 are formed in grooves 311a formed in the first panel 311 to correspond to the discharge cells of red, green, and blue. The grooves 311a are formed in portions of the first panel 311 corresponding to the discharge cells 360 by a sand blast or etching method. The fluorescent substance applied thereto is similar to that of the above-mentioned embodiment and thus description thereof will be omitted.

A frit 370 is applied between the dielectric wall 322 and the first panel 311. The frit 370 serves to seal the pair of panels 310 through a baking process.

After sealing the plasma display panel 300, a discharge gas such as, for example Ne, Xe, or a mixture thereof is injected into the plasma display panel 300.

Next, a process of manufacturing the plasma display panel 300 according to one embodiment and the operation thereof will be specifically described.

The process of manufacturing the plasma display panel 300 can include: forming the barrier ribs 321 and the dielectric wall 322 on the second panel 312; forming the phosphor layers 350; assembling and sealing the plasma display panel 300; and injecting the discharge gas into the plasma display panel 300.

First, the process of forming the barrier ribs 321 and the dielectric wall 322 on the second panel 312 will be described. The barrier ribs are formed by stacking a dielectric substance on the second panel 312. In the course of stacking, the discharge parts of the third discharge electrodes 333, the discharge parts 332a of the second discharge electrodes 332, and the discharge parts of the first discharge electrodes 331 are sequentially buried and stacked. In this case, a sand blast method, a screen printing method, or the like can be used.

The dielectric wall 322 is formed by stacking a dielectric substance on the second panel 312. In the course of stacking, the portions of the third discharge electrodes 333, the second discharge electrodes 332, and the first discharge electrodes 331 to be buried in the dielectric wall 322 are sequentially stacked. In this case, a sand blast method, a screen printing method, or the like can be used.

After forming the barrier ribs 321 and the dielectric wall 322, the terminal parts 332b are formed at ends of the connection parts 332c of the second discharge electrodes 332. At this time, the gap A₂ between the terminal parts 332b is greater than the gap B₂ between the wires 341 of the signal transmission member 340.

The terminal parts (not shown) of the first discharge electrodes 331 and the third discharge electrodes 333 have the structure similar to the terminal parts 332b of the second discharge electrodes 332.

The protective layer 321a made of magnesium oxide is formed on the sidewalls of the barrier ribs 321 through the use of a vacuum deposition method.

On the other hand, the parts of the first panel 311 corresponding to the discharge cells 360 are etched through the use of a glass cutting method such as, for example, a sand blast method and an etching method to form the grooves 311a. Then, the fluorescent substances are applied to the grooves 311a to form the phosphor layers 350.

Next, the first panel 311 and the second panel 312 are assembled. In the course of assembling the panels, the frit 370 is applied such properly that the frit 370 is positioned between the first panel 311 and the dielectric part 322.

After assembling the panels, a vacuum exhaust process is performed and then the discharge gas is injected.

After injection of the discharge gas, the exposed terminal parts 331b and the wires 341 of the signal transmission member 340 are bonded to each other by the use of the anisotropic conductive film.

The operations of the plasma display panel 300 manufactured through the above-mentioned processes will now be described.

After the assembly of the plasma display panel 300 and the injection of the discharge gas, the address discharge is generated in response to application of a predetermined address voltage between the discharge electrodes serving as a scan electrode among the first discharge electrodes 331 and the third discharge electrodes 333 and the second discharge electrodes 332 and the discharge cells 360 to generate the sustain discharge are selected as a result of the address discharge.

Thereafter, when a discharge sustaining voltage is applied between the first discharge electrodes 331 and the third discharge electrodes 333 of the selected discharge cells 360, wall charges accumulated on the sidewalls of the barrier ribs 321 are migrated by the first discharge electrodes 331 and the third discharge electrodes 333, thereby generating the sustain discharge. At the time of the sustain discharge, the energy level of the excited discharge gas is lowered, thereby emitting the ultraviolet rays.

Then, the ultraviolet rays excite the fluorescent substances of the phosphor layers 350 formed in the discharge cells 360. The energy levels of the excited fluorescent substances are lowered to emit the visible rays. The emitted visible rays pass through the first panel 311 to form an image which can be recognized by persons.

In the present embodiment, since the gap A₂ between the neighboring terminal parts is greater than the gap B₂ between the neighboring wires 341 of the signal transmission member 340, it is possible to prevent short circuits due to electrode migration, impurity migration, and foreign substances between the terminal parts, thereby lowering a failure rate of the terminal parts.

In addition, in the plasma display panel 300 according to the present embodiment, the discharge parts of the first discharge electrodes 331, the second discharge electrodes 332, and the third discharge electrodes 333 surround the discharge cells 360. As a result, the sustain discharge is generated along all the sides of the discharge cells 360, thereby relatively increasing a discharge area and causing increase in emission brightness and discharge efficiency.

As described above, in the plasma display panel according to the present embodiments, since the gap between the terminal parts of the discharge electrodes is greater than the gap between the wires of the signal transmission member, it is possible to prevent short circuits due to electrode migration, impurity migration, and foreign substances between the terminal parts. Then, it is also possible to improve quality of the plasma display panel and to lower the failure rate of the terminal parts, thereby reducing the manufacturing cost.

In the plasma display panel according to the present embodiments, since the discharge parts of the discharge electrodes are buried in the sheet or the barrier ribs and surround the discharge cells, the discharge area can relatively increase and the emission brightness and the discharge efficiency can also increase.

In addition, the plasma display panel according to the present embodiments can include the sheet. Accordingly, the manufacturing processes can be simplified, thereby reducing the manufacturing cost.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. A plasma display panel comprising:
a pair of panels spaced from each other and substantially opposed to each other;
a sheet disposed between the pair of panels which includes barrier ribs defining discharge cells and a dielectric part disposed at edge;
discharge electrodes which include discharge parts configured to generate discharge inside the barrier ribs, terminal parts spaced a pre-determined distance from each other and formed in contact with the dielectric part, and connection parts connecting the discharge parts to the terminal parts;
a signal transmission member including wires spaced a pre-determined distance from each other smaller than the distance between the terminal parts and connected to the terminal parts;
phosphor layers disposed inside the discharge cells; and
discharge gas in the discharge cells.

2. The plasma display panel of claim 1, wherein the sidewalls of the barrier ribs are covered with a protective layer.

3. The plasma display panel of claim 1, wherein frit is disposed between the pair of panels and the dielectric part.

4. The plasma display panel of claim 1, wherein the discharge parts are disposed to surround at least part of the discharge cells.

5. The plasma display panel of claim 1, wherein the discharge parts are disposed in a stripe shape.

6. The plasma display panel of claim 1, further comprising grooves formed on at least one panel of the pair of panels wherein the grooves are coated with the phosphor layer.

7. The plasma display panel of claim 1, wherein the signal transmission member is a flexible printed cable.

8. The plasma display panel of claim 1, wherein the signal transmission member is a tape carrier package.

9. The plasma display panel of claim 1, wherein the wires of the signal transmission member and the terminal parts are connected to each other through an anisotropic conductive film.

10. A plasma display panel comprising:
a pair of panels spaced from each other and substantially opposed to each other;
barrier ribs which are disposed between the pair of panels and define discharge cells with the pair of panels;
discharge electrodes disposed between the pair of panels which include terminal parts spaced a pre-determined distance from each other at the ends of the discharge electrodes;
a signal transmission member including wires spaced a pre-determined distance from each other smaller than the distance between the terminal parts and connected to the terminal parts;
phosphor layers disposed inside the discharge cells; and
discharge gas in the discharge cells.

11. The plasma display panel of claim 10, wherein the sidewalls of the barrier ribs are covered with a protective layer.

12. The plasma display panel of claim 10, wherein frit is disposed between the pair of panels.

13. The plasma display panel of claim 10, wherein at least a part of the discharge electrodes is disposed to surround at least part of the discharge cells.

14. The plasma display panel of claim 10, wherein at least a part of the discharge electrodes is disposed in a stripe shape.

15. The plasma display panel of claim 10, further comprising grooves formed on at least one panel of the pair of panels wherein the grooves are coated with the phosphor layer.

16. The plasma display panel of claim 10, wherein the signal transmission member is a flexible printed cable.

17. The plasma display panel of claim 10, wherein the signal transmission member is a tape carrier package.

18. The plasma display panel of claim 10, wherein the wires of the signal transmission member and the terminal parts are connected to each other through an anisotropic conductive film.
